(19) United States
(12) Patent Application Publication
(10) Pub. No.: US 2025/0284246 A1
(43) Pub. Date: Sep. 11, 2025

(54) TIMEPIECE, DISPLAY CONTROL METHOD, AND STORAGE MEDIUM

(71) Applicant: CASIO COMPUTER CO., LTD., Tokyo (JP)

(72) Inventors: Shuto OIKAWA, Tokyo (JP); Kotaro YOSHIDA, Tokyo (JP)

(21) Appl. No.: 19/069,788

(22) Filed: Mar. 4, 2025

(30) Foreign Application Priority Data
Mar. 5, 2024 (JP) 2024-032601

(51) Int. Cl. G04C 10/02; G04C 3/00; G04C 3/14; G04C 13/04; G04C 17/02

(52) U.S. Cl. CPC G04C 10/02; G04C 3/008; G04C 3/14; G04C 13/0409; G04C 17/02

(57) ABSTRACT

A timepiece includes a first display including a hand, a second display, a solar panel provided at a position having a possibility that external light is blocked by the hand that is displaying time, and at least one processor that controls an operation mode of the first display and the second display. The at least one processor switches the operation mode between a first mode in which the hand of the first display displays the time and a second mode in which the hand is evacuated to a predetermined evacuation position that makes the external light that is blocked by the hand less as compared to in the first mode and the second display displays the time.

### CROSS-REFERENCE TO RELATED APPLICATIONS

This application is based upon and claims the benefit of priority from the prior Japanese Patent Application No. 2024-032601 filed on Mar. 5, 2024, the entire contents of which are incorporated herein by reference.

### TECHNICAL FIELD

The present disclosure relates to a timepiece, a display control method, and a storage medium.

### DESCRIPTION OF RELATED ART

As disclosed in JP 2003-57366 A, there is a timepiece in which a secondary battery is chargeable by electric power generated by a solar panel. In this kind of timepiece, if its hands, such as an hour hand and a minute hand, cast shadows on the solar panel, the power generation efficiency decreases. To deal with this, there is known a technique of, for example, in a case where the remaining life of the secondary battery is low, evacuating the hands to a position that makes the power generation efficiency of the solar panel less likely to decrease, thereby efficiently charging the secondary battery.

### SUMMARY OF THE INVENTION

According to an aspect of the present disclosure, there is provided a timepiece including:
a first display including a hand;
a second display;
a solar panel provided at a position having a possibility that external light is blocked by the hand that is displaying time; and
at least one processor that controls an operation mode of the first display and the second display,
wherein the at least one processor switches the operation mode between a first mode in which the hand of the first display displays the time and a second mode in which the hand is evacuated to a predetermined evacuation position that makes the external light that is blocked by the hand less as compared to in the first mode and the second display displays the time.

### BRIEF DESCRIPTION OF DRAWINGS

FIG. 1 is a block diagram illustrating a functional configuration of an electronic timepiece.

FIG. 2 is a plan view of the electronic timepiece to illustrate a first display, a second display, a third display and so forth.

FIG. 3 is a schematic sectional view of the electronic timepiece taken along line A-A in FIG. 2.

FIG. 4 illustrates the electronic timepiece operating in a second mode.

FIG. 5 is a flowchart of a control procedure for an operation mode control process.

FIG. 6 illustrates a method for determining an evacuation position in a first modification.

FIG. 7 illustrates an example of temporal change in electromotive force of a solar panel while hands are making a round.

FIG. 8 illustrates the electronic timepiece according to a second modification, the electronic timepiece operating in the second mode.

FIG. 9 is a front view of the electronic timepiece according to a second embodiment.

FIG. 10 is a front view of the electronic timepiece according to the second embodiment, the electronic timepiece operating in the second mode.

FIG. 11 is a front view of another example of the electronic timepiece according to the second embodiment.

FIG. 12 is a front view of the example of the electronic timepiece according to the second embodiment, the electronic timepiece operating in the second mode.

### DETAILED DESCRIPTION

Hereinafter, one or more embodiments of the present disclosure will be described with reference to the drawings.

### First Embodiment

### <Configuration of Electronic Timepiece>

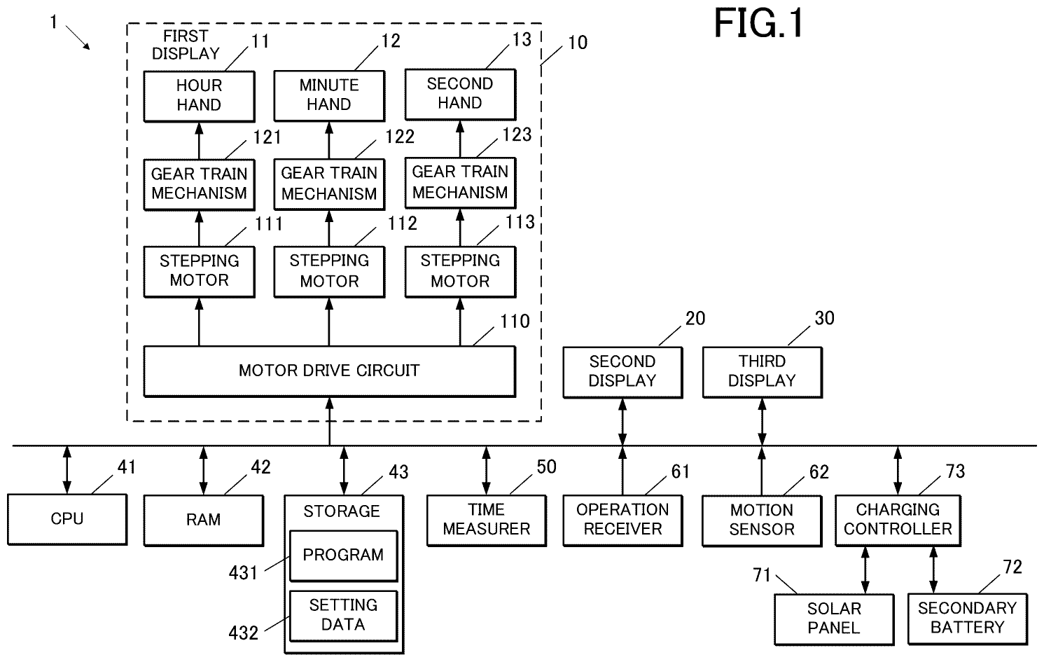

FIG. 1 is a block diagram illustrating a functional configuration of an electronic timepiece 1 (timepiece). The electronic timepiece 1 is a wristwatch (wearable device) that is worn on a wrist of a user with a band (not illustrated). The electronic timepiece 1 includes a first display 10, a second display 20, a third display 30, a central processing unit (CPU) 41 (at least one processor), a random access memory (RAM) 42, a storage 43, a time measurer 50, an operation receiver 61, a motion sensor 62, a solar panel 71, a secondary battery 72, and a charging controller 73. These components of the electronic timepiece 1 are connected with one another via a communication path, such as a bus, and operate by electric power supplied from the secondary battery 72.

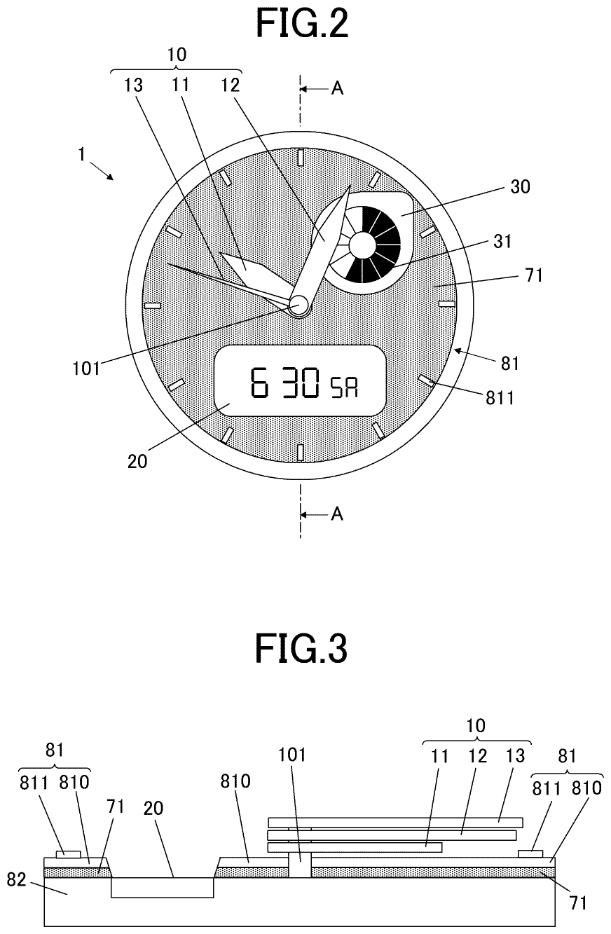

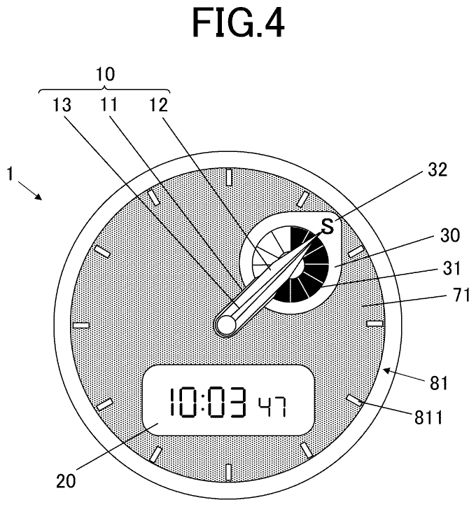

FIG. 2 is a plan view of the electric timepiece 1 to illustrate the first display 10, the second display 20, the third display 30 and so forth. The first display 10 includes an hour hand 11, a minute hand 12 and a second hand 13 that rotate around a rotation shaft 101 at the center of a circular dial 81. Hereinafter, the hour hand 11, the minute hand 12 and the second hand 13 may be referred to as “hands 11 to 13”. The first display 10 displays time in an analog form with the hands 11 to 13. The second display 20 is disposed at six o'clock (6:00) side of the rotation shaft 101. The second display 20 includes a segmented liquid crystal panel, and displays information such as the time, a date and a day of the week in a digital form. The third display 30 is disposed at the upper right from (1:30 side of) the rotation shaft 101. The third display 30 includes a segmented liquid crystal panel, and displays second segments 31 indicating a lapse of seconds, an evacuation position mark 32 (in FIG. 4), which will be described later, and so forth.

FIG. 3 is a schematic sectional view of the electronic timepiece 1 taken along line A-A in FIG. 2. The components illustrated in FIG. 3 are housed in a case (not illustrated). The case is opened on the display surface side, and this opening is sealed with a transparent crystal (not illustrated). The electronic timepiece 1 includes a module 82 in which components for operating the first display 10, the second display 20 and the third display 30 are housed. The hands 11 to 13 rotate independently of one another in response to rotations of the rotation shaft 101 attached to the module 82. On the surface of the module 82 facing the hands 11 to 13 (display surface side), the solar panel 71 and the dial 81 are laid in this order. The dial 81 includes decorative members, such as indexes 811 illustrated in FIG. 2, and the part other than the decorative members is a light transmitting part 810 made of a material having optical transparency (semi-transparent material). External light having passed through the light transmitting part 810 of the dial 81 is incident on the solar panel 71. The decorative members may also be made of a semi-transparent material.

Hereinafter, viewing the electronic timepiece 1 in a direction perpendicular to the solar panel 71 (extension direction of the rotation shaft 101) may be referred to as “in plan view”. As illustrated in FIG. 3, the solar panel 71 and the dial 81 each have an opening in a region where the second display 20 is provided in plan view. Although not illustrated in FIG. 3, the solar panel 71 and the dial 81 each also have an opening in a region where the third display 30 is provided in plan view. That is, the solar panel 71 is provided in a region where neither the second display 20 nor the third display 30 is provided in plan view. In FIG. 2, the region where the solar panel 71 is provided is shown in color. Since the hands 11 to 13 rotate on the solar panel 71, the hands 11 to 13 that are displaying the time might block the external light from being incident on the solar panel 71. Thus, the solar panel 71 is provided at a position having a possibility that the external light is blocked by the hands 11 to 13 that are displaying the time. In other words, the solar panel 71 is provided at a position having a possibility that the hands 11 to 13 cast shadows on part of the solar panel 71 in plan view.

As illustrated in FIG. 1, the first display 10 further includes gear train mechanisms 121, 122, 123 that are gear trains connected to the hour hand 11, the minute hand 12 and the second hand 13, respectively, stepping motors 111, 112, 113 that rotate the gear train mechanisms 121, 122, 123, respectively, and a motor drive circuit 110 that drives the stepping motors 111, 112, 113. The hour hand 11 rotates angle by angle, the angle corresponding to one second, in response to the stepping of the stepping motor 111 transmitted thereto via the gear train mechanism 121. The minute hand 12 rotates angle by angle, the angle corresponding to one second, in response to the stepping of the stepping motor 112 transmitted thereto via the gear train mechanism 122. The second hand 13 rotates angle by angle, the angle corresponding to one second, in response to the stepping of the stepping motor 113 transmitted thereto via the gear train mechanism 123. The rotation angle of the second hand 13 corresponding to one second is six degrees. The rotation angle of the minute hand 12 corresponding to one second is 1/60 of the rotation angle of the second hand 13. The rotation angle of the hour hand 11 corresponding to one second is 1/12 of the rotation angle of the minute hand 12.

The stepping motors 111 to 113 each are step-driven on the basis of the voltage waveform of a drive pulse input from the motor drive circuit 110 to rotate and move their corresponding hands 11 to 13 in the normal direction (clockwise direction in which the time advances) or the reverse direction (counterclockwise direction in which the time goes back) by their respective predetermined rotation angles mentioned above. During the time display, the stepping motors 111 to 113 are driven by a drive pulse of 1 pulse per second (pps). The stepping motors 111 to 113 can be driven by a drive pulse of up to about several tens to several hundreds pps in the normal direction and the reverse direction to rotate the hands 11 to 13 in the normal direction or the reverse direction in a fast-forward manner. Since the hour hand 11, the minute hand 12 and the second hand 13 are connected to their respective gear train mechanisms and stepping motors, they can rotate independently of one another. In accordance with a control signal input from the CPU 41, the motor drive circuit 110 outputs, at an appropriate timing and with an appropriate pulse width, a drive voltage pulse for driving each of the stepping motors 111 to 113 to perform the stepping.

The second display 20 and the third display 30 each include a liquid crystal panel and a drive circuit for the liquid crystal panel. The second display 20 and the third display 30 each perform the aforementioned segment display on the liquid crystal panel in accordance with a control signal and image data transmitted from the CPU 41 to the drive circuit.

The CPU 41 is a processor that functions as a controller that controls operation of the electronic timepiece 1 by reading and executing programs 431 stored in the storage 43 and performing various types of arithmetic processing accordingly. The electronic timepiece 1 may have a plurality of processors (e.g., CPUs), and processes that are performed by the CPU 41 of this embodiment may be performed by the processors. In this case, the processors constitute the controller. The processors may be involved in the same process(es), or independently perform different processes in parallel. The RAM 42 provides a working memory space for the CPU 41 and stores temporary data.

The storage 43 is a non-transitory storage medium readable by the CPU 41 as a computer, and stores the programs 431 and various data, such as setting data 432. The storage 43 includes a nonvolatile memory, such as a flash memory. The programs 431 are stored in the storage 43 in the form of computer-readable program codes. In the setting data 432, data regarding various operation settings of the electronic timepiece 1 are stored.

The time measurer 50 includes an oscillator circuit, a frequency divider circuit and a time measurement circuit. In the time measurer 50, the frequency divider circuit divides the frequency of a clock signal generated by the oscillator circuit, and the time measurement circuit counts the frequency-divided signals. Thus, the time measurer 50 derives and keeps the current date and time.

The operation receiver 61 includes operation elements (not illustrated), such as operation buttons and a crown, and outputs operation signals corresponding to operations on the operation elements to the CPU 41.

The motion sensor 62 includes a three-axis acceleration sensor and a three-axis angular velocity sensor, and detects the acceleration and the angular velocity of the electronic timepiece 1 that are generated according to the movement of the user's wrist. On the basis of the acceleration and the angular velocity detected by the motion sensor 62, the CPU 41 determines whether the electronic timepiece 1 is worn by the user.

The solar panel 71 includes solar cells (not illustrated) connected in series. Each solar cell generates electromotive force due to the photoelectric effect according to the external light that is incident thereon. The solar panel 71 outputs the sum of the amounts of the electromotive force of the solar cells. The solar cells may have approximate fan shapes into which the circle formed by the dial 81 illustrated in FIG. 2 is divided by separator lines extending in the radial direction, or may form a whirlpool shape with the position of the rotation shaft 101 as its center/start point, for example. The solar cells may have shapes different from one another so that the solar panel 71 is provided in the region where neither the second display 20 nor the third display 30 is provided.

The secondary battery 72 is a battery that is chargeable and dischargeable. The secondary battery 72 is charged by electric current generated by the electromotive force of the solar panel 71 flowing thereinto.

The charging controller 73 is electrically connected to the solar panel 71 and the secondary battery 72. In accordance with a control signal transmitted from the CPU 41, the charging controller 73 controls the charging that is performed by the solar panel 71 on the secondary battery 72. Also, in accordance with a control signal transmitted from the CPU 41, the charging controller 73 detects the electromotive force of the solar panel 71 and transmits the detection result to the CPU 41. The charging controller 73 may be capable of detecting the remaining life of the secondary battery 72.

The electronic timepiece 1 may include components not illustrated in FIG. 1, such as a communicator that communicates with external devices and a position information obtainer that receives and decodes radio waves transmitted from positioning satellites to calculate the current position.

### <Operation of Electronic Timepiece>

Next, the operation of the electronic timepiece 1 will be described. As described above, in the electronic timepiece 1 of this embodiment, the rotating hands 11 to 13 might be laid on the solar panel 71 in plan view. If the hands 11 to 13 block the external light and cast shadows on the solar panel 71, the power generation efficiency and the electromotive force of the solar panel 71 decrease, and the charge efficiency of the secondary battery 72 decreases accordingly. Like this embodiment, in the model having the analog first display 10 and the digital second and third displays 20, 30 in combination, the solar panel 71 cannot be provided in the regions of the second display 20 and the third display 30. If the solar panel 71 having a limited area is shadowed by the hands 11 to 13, the power generation efficiency is likely to decrease. This problem is more considerable if the hour hand 11 and the minute hand 12 are designed to be wide and large.

For this reason, in the electronic timepiece 1 of this embodiment, the operation mode of the first display 10, the second display 20 and the third display 30 is switchable between a normal first mode and a second mode that is for reducing a decrease in the power generation efficiency of the solar panel 71. The switching of the operation mode is controlled by the CPU 41.

The first mode is a normal mode for displaying the time. In the first mode, as illustrated in FIG. 2, the CPU 41 causes the first display 10 to display the time (hours, minutes, seconds), causes the second display 20 to display a date and a day of the week, and causes the third display 30 to display the second segments 31. The information displayed by the second display 20 in the first mode is not limited to a date and a day of the week, but any information other than the time.

During the operation in the first mode, if a predetermined change condition to the second mode is satisfied, the CPU 41 changes the operation mode to the second mode. The change condition to the second mode is at least one of the following: the user makes an operation indicating a change to the second mode; it is a predetermined time period (e.g., daytime) in which a high power generation efficiency is obtained; on the basis of the detection result of the motion sensor 62, removal of the electronic timepiece 1 from the user's wrist is detected; strong light is detected by the solar panel 71 (electromotive force is a predetermined upper limit or more); and the remaining life of the secondary battery 72 is less than a predetermined first reference amount. In the second mode, as illustrated in FIG. 4, the CPU 41 evacuates the hands 11 to 13 to and makes them still at a predetermined evacuation position that makes the external light that is blocked by the hands 11 to 13 less than that in the first mode. Also, in the second mode, the CPU 41 causes the second display 20 to display the time digitally. Also, in the second mode, the CPU 41 causes the third display 30 to display the evacuation position mark 32 in addition to the second segments 31. The evacuation position mark 32 in this embodiment is formed of a letter of “S” indicating that the solar panel 71 is performing the charging.

As illustrated in FIG. 4, the CPU 41 evacuates the hands 11 to 13 to the same evacuation position so that the hands 11 to 13 are laid on top of one another. At this evacuation position, the hands 11 to 13 each are partly laid on the third display 30. The evacuation position predetermined is a position at which the hands 11 to 13 are not laid on the second display 20 and the area of a part of the solar panel 71 is the smallest, the part where the external light is blocked by the hands 11 to 13. In other words, the evacuation position predetermined is a position at which the area of an overlap of the third display 30 and the hands 11 to 13 as viewed in the direction perpendicular to the solar panel 71 is the largest. This makes, of the external light to be incident on the solar panel 71, the external light that is blocked by the hands 11 to 13 less than that in the first mode. Evacuating the hands 11 to 13 to this evacuation position can maximize the power generation efficiency of the solar panel 71 without interference with the time display by the second display 20. The evacuation position mark 32 is displayed at a position to which the hands 11 to 13 at the evacuation position point. In other words, in the second mode, the CPU 41 causes the hands 11 to 13 to point to the evacuation position mark 32.

During the operation in the second mode, if a predetermined change condition to the first mode is satisfied, the CPU 41 changes the operation mode to the first mode. The change condition to the first mode is at least one of the following: the user makes an operation indicating a change to the first mode; it is a predetermined time period (e.g., nighttime) in which the power generation efficiency decreases; on the basis of the detection result of the motion sensor 62, wearing of the electronic timepiece 1 on the user's wrist is detected; less strong light is detected by the solar panel 71 (electromotive force is less than a predetermined lower limit); and the remaining life of the secondary battery 72 is a predetermined second reference amount or more. The second reference amount may be the same as or different from the first reference amount.

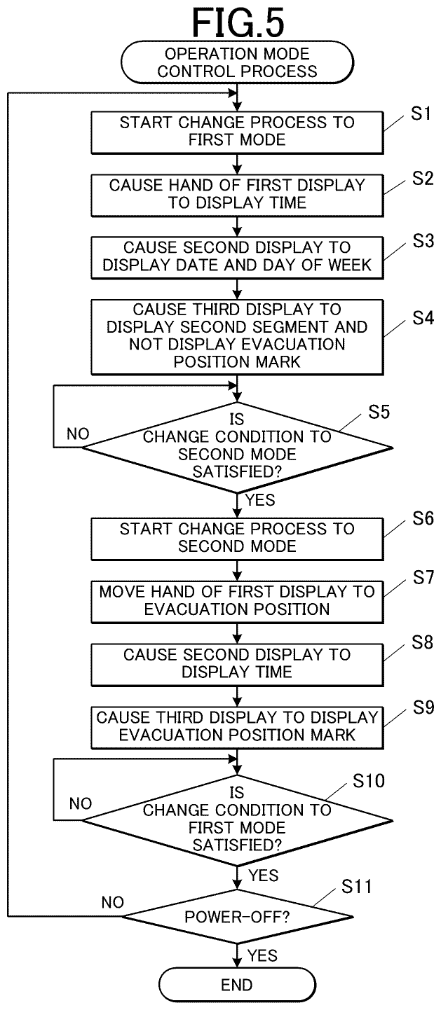

Next, an operation mode control process that is performed by the CPU 41 to realize the above-described operation of the electronic timepiece 1 will be described. FIG. 5 is a flowchart of a control procedure for the operation mode control process. The operation mode control process is started at the time of startup of the electronic timepiece 1. When the operation mode control process is started, the CPU 41 starts a change process to the first mode (Step S1). That is, the CPU 41 transmits a control signal to the motor drive circuit 110 to cause the stepping motors 111 to 113 to operate, thereby causing the hands 11 to 13 of the first display 10 to display the current time being measured by the time measurer 50 (Step S2). The CPU 41 also transmits a control signal to the drive circuit of the second display 20 to cause the second display 20 to display a date and a day of the week (Step S3). The CPU 41 also transmits a control signal to the drive circuit of the third display 30 to cause the third display 30 to display the second segment(s) 31 and not display the evacuation position mark 32 (Step S4).

The CPU 41 repeatedly determines whether the above-described change condition to the second mode is satisfied (Step S5). If the CPU 41 determines that the change condition is satisfied (Step S5; YES), the CPU 41 starts a change process to the second mode (Step S6). That is, the CPU 41 moves the hands 11 to 13 of the first display 10 to the evacuation position (Step S7). In Step S7, the CPU 41 obtains information on the evacuation position by referring to the setting data 432 and transmits a control signal to the motor drive circuit 110 to cause the stepping motors 111 to 113 to operate, thereby rotating the hour hand 11, the minute hand 12 and the second hand 13 independently of one another in the normal direction or the reverse direction to the evacuation position in the fast-forward manner. The CPU 41 also transmits a control signal to the drive circuit of the second display 20 to cause the second display 20 to display the time (Step S8). The CPU 41 also transmits a control signal to the drive circuit of the third display 30 to cause the third display 30 to display the evacuation position mark 32 (Step S9).

The CPU 41 repeatedly determines whether the above-described change condition to the first mode is satisfied (Step S10). If the CPU 41 determines that the change condition is satisfied (Step S10; YES), the CPU 41 determines whether an operation to power off the electronic timepiece 1 has been made (Step S11). If the CPU 41 determines that the operation has not been made (Step S11; NO), the CPU 41 returns the process to Step S1, whereas if the CPU 41 determines that the operation has been made (Step S11; YES), the CPU 41 ends the operation mode control process. In a case where no power-off operation is set, the CPU 41 may return the process to Step S1 after “Step S10; YES”. That is, the loop process of Steps S1 to S10 may be repeatedly performed until the power of the secondary battery 72 runs out.

### First Modification

Next, a first modification of the first embodiment will be described. Hereinafter, different points between this modification and the first embodiment will be described. In the above embodiment, the evacuation position in the second mode is preset and registered in the setting data 432, but in this modification, at the time of the change to the second mode, an evacuation position suitable to obtain a high power generation efficiency is determined. In this modification, as an example, the electronic timepiece 1 does not have the third display 30.

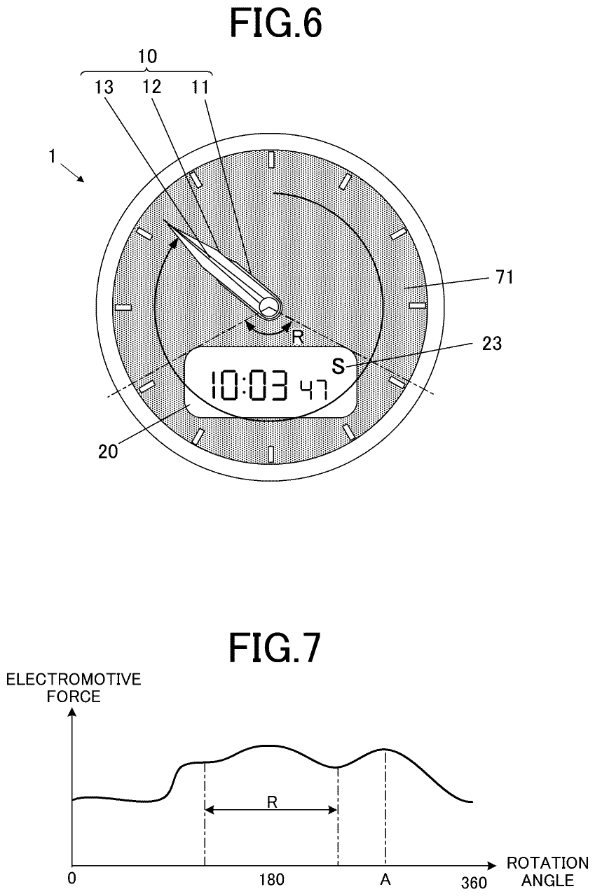

FIG. 6 illustrates a method for determining the evacuation position in the first modification. In this modification, when the operation mode is changed to the second mode, the CPU 41 causes the hands 11 to 13 to make a round in a state in which the hands 11 to 13 are laid on top of one another, and obtains, from the charging controller 73, temporal change in the electromotive force of the solar panel 71. The speed at which the hands 11 to 13 make a round can be appropriately determined according to a response speed at which the electromotive force of the solar panel 71 changes according to the external light incident on the solar panel 71. This speed may be several times as fast as the normal rotation speed of the second hand 13, for example. Of the hands 11 to 13, only the hour hand 11 and the minute hand 12 may be caused to make a round, and the second hand 13 may be caused to continue its normal time display. This is because the second hand 13, which is thinner than the minute hand 12, has only a little influence on the power generation efficiency of the solar panel 71.

FIG. 7 illustrates an example of the temporal change in the electromotive force of the solar panel 71 while the hands 11 to 13 are making a round. The horizontal axis in FIG. 7 represents the rotation angle of the hands 11 to 13 with twelve o'clock as 0°. An angle range R represents a range of angles at which the hands 11 to 13 are laid on part of the second display 20. As illustrated in FIG. 7, the amounts of the electromotive force at angles are not necessarily the same. For example, if the solar panel 71 is shadowed by an object other than the hands 11 to 13, the electromotive force is higher in a state in which the hands 11 to 13 are in the shadow than in a state in which the hands 11 to 13 are not in the shadow. Examples of the situation in which the solar panel 71 is shadowed by an object other than the hands 11 to 13 include a situation in which the external light is incident on the solar panel 71 in a direction inclined from the direction perpendicular to the solar panel 71, so that the side wall of the case of the electronic timepiece 1 and/or the bezel thereof cast shadows on the solar panel 71, and a situation in which the electronic timepiece 1 is at the border between a sunny place and a shady place.

On the basis of the obtained temporal change in the electromotive force, the CPU 41 determines, as the evacuation position, a position of the hands 11 to 13 at which the magnitude of the electromotive force satisfies a predetermined condition. Examples of the predetermined condition include a condition that the electromotive force at is the largest outside the angle range R and a condition the electromotive force is a predetermined reference value or more outside the angle range R. In the example illustrated in FIG. 7, the CPU 41 identifies, from among angles outside the angle range R, an angle A at which the electromotive force of the solar panel 71 is the largest, and determines a position corresponding to the identified angle A as the evacuation position. In this modification, the hands 11 to 13 evacuated to the evacuation position cannot point to an evacuation position mark. Therefore, the CPU 41 causes the second display 20 to display an evacuation position mark 23. Alternatively, a function hand (not illustrated) may be provided to point to an evacuation position mark. The process of determining the evacuation position with the above-described method and evacuating the hands 11 to 13 thereto may be performed only once when the operation mode is changed to the second mode, or performed repeatedly at a predetermined frequency (e.g., once per hour) during the operation in the second mode.

### Second Modification

Next, a second modification of the first embodiment will be described. Hereinafter, different points between this modification and the first embodiment will be described. The second modification may be combined with the first modification. In this modification, as an example, the electronic timepiece 1 does not have the third display 30. In the above embodiment, the evacuation position predetermined is the position at which the hands 11 to 13 are not laid on the second display 20 but laid on the third display 30. However, for example, in a case where the third display 30 is not provided and the solar panel 71 is provided in the entire region excluding the region of the second display 20, it is preferable from the perspective of the reduction of the decrease in the power generation efficiency that the evacuation position predetermined be a position at which the hands 11 to 13 are laid on the second display 20. This modification may be applied to a case too where the region excluding the region of the second display 20 includes a region where the solar panel 71 is not provided.

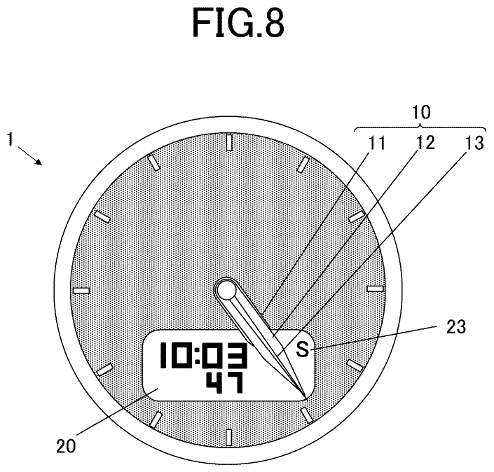

FIG. 8 illustrates the electronic timepiece 1 according to the second modification, the electronic timepiece 1 operating in the second mode. As illustrated in FIG. 8, in this modification, the evacuation position predetermined is a position at which parts of the hands 11 to 13 are laid on a part of the second display 20. The CPU 41 causes the second display 20 to display the time in, of the second display 20, a region on which the hands 11 to 13 are not laid. The second display 20 of this modification has a dot-matrix liquid crystal panel in which pixels are arranged in a matrix. The CPU 41 identifies, in the second display 20, a region of pixels on which the hands 11 to 13 are not laid, and transmits a control signal and image data to the second display 20 for displaying the time in the region. In FIG. 8, the CPU 41 causes the second display 20 to display the evacuation position mark 23. Alternatively, a function hand (not illustrated) may be provided to point to an evacuation position mark.

### Advantageous Effects

As described above, there is known a technique of, in a timepiece in which a secondary battery is chargeable by electric power generated by a solar panel, evacuating hands of the timepiece to a position at which the power generation efficiency of the solar panel is less likely to decrease, thereby efficiently charging the secondary battery. However, this technique has a problem that the time cannot be displayed during the period in which the hands are evacuated. To deal with this, the electronic timepiece 1 according to the first embodiment of the present disclosure is configured as follows and can obtain the following advantageous effects. The electronic timepiece 1 according to the first embodiment includes the first display 10 including the hands 11 to 13 (hand), the second display 20, the solar panel 71 provided at a position having a possibility that the external light is blocked by the hands 11 to 13 that are displaying the time, and the CPU 41 (at least one processor) that controls the operation mode of the first display 10 and the second display 20. The CPU 41 switches the operation mode between the first mode in which the hands 11 to 13 of the first display 10 display the time and the second mode in which the hands 11 to 13 are evacuated to a predetermined evacuation position that makes the external light that is blocked by the hands 11 to 13 less as compared to in the first mode and the second display 20 displays the time. Thus, in the second mode, the hands 11 to 13 are evacuated to the evacuation position, which can reduce the decrease in the power generation efficiency of the solar panel 71, and also the second display 20 can display the time. Further, since the electronic timepiece 1 can operate in the second mode, the amount of power generated per day and the amount of charge of the secondary battery 72 per day can be increased, so that functions conventionally unable to be provided due to a limitation on power consumption can be added. Further, decrease in size of the electronic timepiece 1, increase in areas of the second display 20 and the third display 30, and increase in widths of the hands 11 to 13 are available, and the degree of freedom in design or plan can be enhanced accordingly.

Further, the hands 11 to 13 include the hour hand 11 and the minute hand 12, and in the second mode, the CPU 41 evacuates the hour hand 11 and the minute hand 12 to the same evacuation position so that the hour hand 11 and the minute hand 12 are laid on top of one another. This can minimize the area of the shadow made by the hour hand 11 and the minute hand 12 and more effectively reduce the decrease in the power generation efficiency of the solar panel 71 accordingly.

Further, in the first modification, the CPU 41 causes the hour hand 11 and the minute hand 12 (and the second hand 13) that are laid on top of one another to make a round, obtains the temporal change in the electromotive force generated by the solar panel 71, and determines a position of the hour hand 11 and the minute hand 12, the position at which the magnitude of the electromotive force satisfies a predetermined condition, as the evacuation position. Thus, the hour hand 11 and the minute hand 12 can be evacuated to the optimum evacuation position for effectively reducing the decrease in the power generation efficiency, for example, in a case where light strikes only part of the dial 81 or in a case where light strikes the dial 81 at an angle.

Further, in the second mode, the CPU 41 causes the hands 11 to 13 to point to the evacuation position mark 32 indicating that the electronic timepiece 1 is operating in the second mode. This makes it unlikely that the user misunderstands that the first display 10 is displaying the time in the second mode.

Further, the electronic timepiece 1 further includes the third display 30, the solar panel 71 is provided in the region where the third display 30 is not provided as viewed in the direction perpendicular to the solar panel 71, and in the second mode, the CPU 41 evacuates the hands 11 to 13 to the evacuation position at which parts of the hands 11 to 13 are laid on the third display 30. This can effectively reduce the area of an overlap of the hands 11 to 13 and the solar panel 71.

Further, in the second mode, the CPU 41 causes the third display 30 to display the evacuation position mark 32 indicating that the electronic timepiece 1 is operating in the second mode, and causes the hands 11 to 13 to point to the evacuation position mark 32. This makes it unlikely that the user misunderstands that the first display 10 is displaying the time in the second mode. Further, since the evacuation position mark 32 is displayed only in the second mode, the design of the electronic timepiece 1 in the first mode can be maintained.

Further, the solar panel 71 is provided at least in a part of the region where the second display 20 is not provided as viewed in the direction perpendicular to the solar panel 71, and the evacuation position is a position at which the hands 11 to 13 are not laid on the second display 20 and the area of a part of the solar panel 71 is the smallest, the part where the external light is blocked by the hands 11 to 13. This can most effectively reduce the area of the overlap of the hands 11 to 13 and the solar panel 71 without interference with the time display by the second display 20.

Further, in the second modification, in the second mode, the CPU 41 evacuates the hands 11 to 13 to the evacuation position at which parts of the hands 11 to 13 are laid on a part of the second display 20, and causes the second display 20 to display the time in a region of the second display 20, the region on which the hands 11 to 13 are not laid. This can effectively reduce the area of the overlap of the hands 11 to 13 and the solar panel 71. Further, even in the state in which the hands 11 to 13 are laid on a part of the second display 20, the second display 20 can display the time visibly.

Further, the display control method of the electronic timepiece 1 according to this embodiment includes switching the operation mode of the first display 10 and the second display 20 between the first mode in which the hands 11 to 13 (hand) of the first display 10 display the time and the second mode in which the hands 11 to 13 are evacuated to a predetermined evacuation position that makes the external light that is blocked by the hands 11 to 13 less as compared to in the first mode and the second display 20 displays the time. Thus, in the second mode, the hands 11 to 13 are evacuated to the evacuation position, which can reduce the decrease in the power generation efficiency of the solar panel 71, and also the second display 20 can display the time.

Further, the storage 43 as the non-transitory computer-readable storage medium according to this embodiment stores the program(s) 431 executable by the CPU 41. The program 431 causes the CPU 41 to switch the operation mode of the first display 10 and the second display 20 between the first mode in which the hands 11 to 13 (hand) of the first display 10 display the time and the second mode in which the hands 11 to 13 are evacuated to a predetermined evacuation position that makes the external light that is blocked by the hands 11 to 13 less as compared to in the first mode and the second display 20 displays the time. Thus, in the second mode, the hour hands 11 to 13 are evacuated to the evacuation position, which can reduce the decrease in the power generation efficiency of the solar panel 71, and also the second display 20 can display the time.

### Second Embodiment

Next, a second embodiment will be described. Hereinafter, different points from the first embodiment will be described, and descriptions of components in common with the first embodiment will be omitted. The second embodiment may be combined with one or both of the first modification and the second modification of the first embodiment.

FIG. 9 is a front view of the electronic timepiece 1 according to the second embodiment, the electronic timepiece 1 operating in the first mode. The second display 20 of this embodiment includes a sub hour hand 21 and a sub minute hand 22, and displays the time with the sub hour hand 21 and the sub minute hand 22. For example, while the first display 10 displays the current time, the second display 20 displays the local time (world time) of a preset city in the world. The sub hour hand 21 has an area smaller than that of the hour hand 11, and the sub minute hand 22 has an area smaller than that of the minute hand 12. The areas of the hour hand 11, the minute hand 12, the sub hour hand 21 and the sub minute hand 22 are the areas of regions occupied by the respective hands as viewed in the direction perpendicular to the solar panel 71.

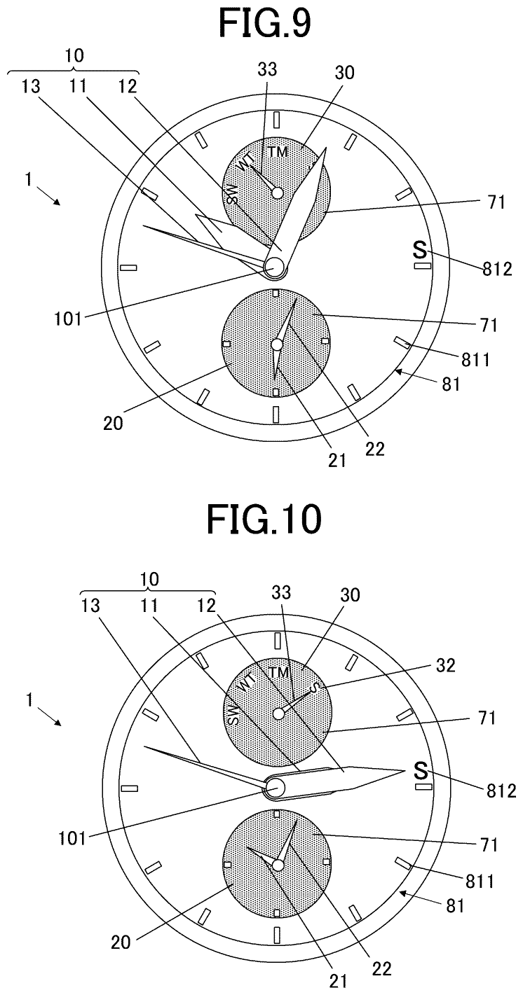

The third display 30 includes a function hand 33, and displays the operation mode and so forth by pointing to various marks with the function hand 33. The marks to which the function hand 33 points include “SW” indicating that the electronic timepiece 1 is operating in a stopwatch mode, “WT” indicating that the electronic timepiece 1 is operating in a world time display mode, “TM” indicating that the electronic timepiece 1 is operating in a timer mode, and “S” (in FIG. 10) indicating that the electronic timepiece 1 is operating in the above-described second mode. In this embodiment, the mark “S” corresponds to the evacuation position mark 32.

The second display 20 is circular and disposed at six o'clock side of the rotation shaft 101. The third display 30 is circular and disposed at twelve o'clock side of the rotation shaft 101. Similarly to the first display 10 of the first embodiment, the second display 20 and the third display 30 each include a stepping motor(s) that is driven by the motor drive circuit 110 and a gear train mechanism(s) that transmits the stepping of the stepping motor(s) to the sub hour hand 21 and the sub minute hand 22 or to the function hand 33. The sub hour hand 21 and the sub minute hand 22 may be configured to rotate in connection with one another. That is, the sub hour hand 21 and the sub minute hand 22 may be connected to a gear train mechanism for the sub hour hand 21 and a gear train mechanism for the sub minute hand 22, respectively, that transmit the stepping of one stepping motor that is common to the sub hour hand 21 and the sub minute hand 22.

The solar panel 71 of this embodiment is provided in regions where the circular second display 20 and the circular third display 30 are provided in plan view. The solar panel 71 provided in in-dials (second display 20 and third display 30) is called an in-dial solar panel. The in-dial solar panel has an advantage that the design of the dial 81 located outside the second display 20 and the third display 30 can be enhanced.

FIG. 10 is a front view of the electronic timepiece 1 according to the second embodiment, the electronic timepiece 1 operating in the second mode. In this embodiment, in the second mode, the CPU 41 evacuates the hour hand 11 and the minute hand 12 of the first display 10 to the evacuation position, and causes the sub hour hand 21 and the sub minute hand 22 of the second display 20 to display the time. Since the second display 20 has no second hand, the CPU 41 rotates the second hand 13 of the first display 10 to display seconds in the same manner as in the first mode, but not limited to thereto and may evacuate all the hands 11 to 13 to the evacuation position.

Since the in-dial solar panel 71 generates the power with a small area, even if the solar panel 71 is partly shadowed by the hour hand 11 and the minute hand 12, the power generation efficiency decreases significantly. For this reason, the evacuation position predetermined is a position at which the hour hand 11 and the minute hand 12 are laid on neither the second display 20 nor the third display 30, namely, a position at which the hour hand 11 and the minute hand 12 are not laid on the solar panel 71. Of the dial 81, at a position to which the hands 11, 12 at the evacuation position point, an evacuation position mark 812 is provided. In other words, in the second mode, the CPU 41 causes the hands 11, 12 to point to the evacuation position mark 812. In the second mode, the CPU 41 also causes the function hand 33 to point to the evacuation position mark 32.

The hour hand 11 and the minute hand 12 evacuated to the evacuation position in FIG. 10 point to a position between two o'clock and three o'clock, the position being closer to three o'clock. This arrangement of the hour hand 11 and the minute hand 12 is different from any arrangement thereof that appears during the time display. This arrangement can be realized by the hour hand 11 and the minute hand 12 configured to rotate independently of one another. Evacuating the hour hand 11 and the minute hand 12 to this evacuation position allows the user to intuitively recognize that the first display 10 is not displaying the time.

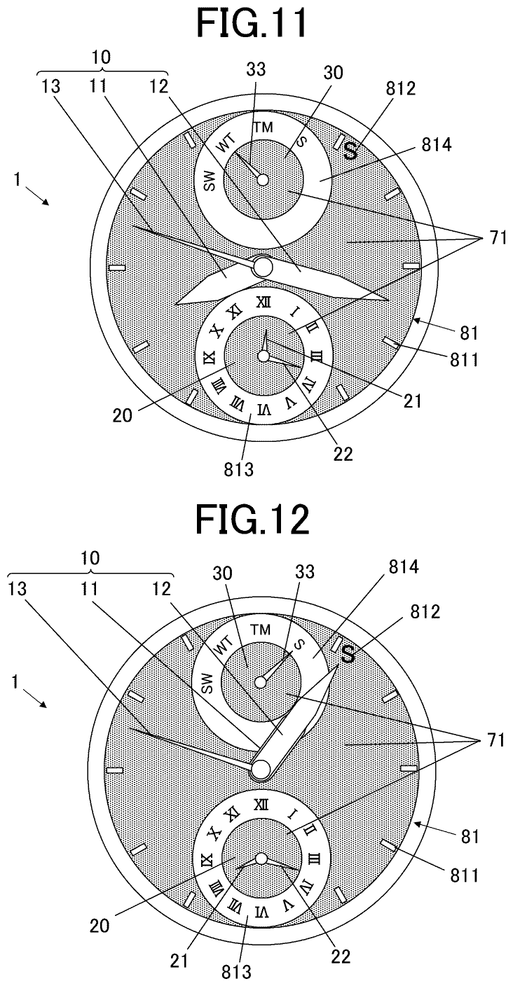

FIG. 11 is a front view of another example of the electronic timepiece 1 according to the second embodiment, the electronic timepiece 1 operating in the first mode. In the electronic timepiece 1 illustrated in FIG. 11, the dial 81 includes an annular decorative part 813 provided around the second display 20 and an annular decorative part 814 provided around the third display 30. The decorative part 813 and the decorative part 814 are made of an opaque material and correspond to a light blocking part that blocks light. Of the dial 81, the part excluding the decorative part 813, the decorative part 814 and the indexes 811 is the light transmitting part 810 (in FIG. 3) having optical transparency. The decorative part 813 has hour characters representing the time that the second display 20 displays. The decorative part 814 has marks to which the function hand 33 of the third display 30 points.

The solar panel 71 is provided in regions where neither the decorative part 813 nor the decorative part 814 is provided as viewed in the direction perpendicular to the solar panel 71. That is, the solar panel 71 is provided in regions that coincide with the inside of the second display 20 in the decorative part 813, the inside of the third display 30 in the decorative part 814, and the region of the dial 81 outside the decorative parts 813, 814. In this specification, the “region(s) where the solar panel 71 is provided” refers to the region in which the solar panel 71 receives light that is to enter the solar panel 71 from the display surface side in the direction perpendicular to the solar panel 71. Therefore, the solar panel 71 may extend to be partly laid on the back surface side of the decorative parts 813, 814. In this form too, the “region(s) where the solar panel 71 is provided” is those colored in FIG. 12.

FIG. 12 is a front view of the electronic timepiece 1 illustrated in FIG. 11, the electronic timepiece 1 operating in the second mode. The predetermined evacuation position in the electronic timepiece 1 illustrated in FIG. 12 is a position at which parts of the hour hand 11 and the minute hand 12 are laid on a part of the decorative part 814. Since the regions where the decorative parts 813, 814 are provided do not contribute to the power generation by the solar panel 71, the hour hand 11 and the minute hand 12 are evacuated to be laid on a part of the decorative part 814 or the decorative part 813. This can reduce the decrease in the power generation efficiency of the solar panel 71. Further, of the dial 81, at the position to which the hands 11, 12 at the evacuation position point, the evacuation position mark 812 is provided.

### Advantageous Effects

As described above, the second display 20 of the electronic timepiece 1 according to the second embodiment includes the sub hour hand 21 having an area smaller than the area of the hour hand 11 and the sub minute hand 22 having an area smaller than the area of the minute hand 12, the solar panel 71 is provided at least in the region where the second display 20 is provided as viewed in the direction perpendicular to the solar panel 71, and in the second mode, the CPU 41 evacuates the hour hand 11 and the minute hand 12 to the evacuation position at which the hour hand 11 and the minute hand 12 are not laid on the second display 20. Thus, in the electronic timepiece 1 using the in-dial solar panel 71, the decrease in the power generation efficiency of the solar panel 71 can be reduced, and also the second display 20 can display the time.

Further, the hands 11 to 13 (hand) include the second hand 13 in addition to the hour hand 11 and the minute hand 12, and in the second mode, the CPU 41 causes the second display 20 to display hours and minutes, and causes the second hand 13 of the first display 10 to display seconds. Thus, although the second display 20 has no second hand, seconds can be displayed in the second mode.

Further, the CPU 41 is capable of rotating the hour hand 11 and the minute hand 12 independently of one another, and in the second mode, evacuates the hour hand 11 and the minute hand 12 to the evacuation position that is a position at which the hour hand 11 and the minute hand 12 are not laid on top of one another while the hour hand 11 and the minute hand 12 are displaying the time. This allows the user to intuitively recognize that the first display 10 is not displaying the time, and makes it unlikely that the user misunderstands that the first display 10 is displaying the time in the second mode accordingly.

Further, the electronic timepiece 1 further includes the dial 81 provided between the hands 11 to 13 and the solar panel 71 and including the light transmitting part 810 that transmits the external light and the decorative parts 813, 814 that block the external light, the solar panel 71 is provided in the regions where neither the decorative part 813 nor the decorative part 814 is provided as viewed in the direction perpendicular to the solar panel 71, and in the second mode, the CPU 41 evacuates the hour hand 11 and the minute hand 12 to the evacuation position at which parts of the hour hand 11 and the minute hand 12 are laid on the decorative part 813 or 814. Thus, the decorative parts 813, 814 are utilized to effectively reduce the area of an overlap of the hands 11, 12 and the solar panel 71.

### Others

The present disclosure is not limited to the above embodiments and the like, and can be modified in a variety of aspects. For example, in FIG. 4 for the first embodiment and FIG. 8 for the second modification, the second hand 13 is evacuated to the evacuation position together with the hour hand 11 and the minute hand 12, but not limited thereto. Since the second hand 13, which is thinner than the minute hand 12, has only a little influence on the power generation efficiency of the solar panel 71, in the second mode, only the hour hand 11 and the minute hand 12 may be evacuated to the evacuation position, and the second hand 13 may be caused to rotate to display seconds as in the first mode. Further, instead of the hour hand 11 and the minute hand 12 configured to point to the evacuation position mark 32 or 812, the second hand 13 may be configured to point to the evacuation position mark 32 or 812 provided or displayed at an appropriate position.

Further, in the above, the hour hand 11 and the minute hand 12 are evacuated to the same evacuation position, but if there are two or more positions usable as the evacuation position for effectively avoiding the decrease in the power generation efficiency of the solar panel 71, the hour hand 11 and the minute hand 12 may be evacuated to different evacuation positions.

Further, in the above, the hour hand 11 and the minute hand 12 are configured to rotate independently of one another, but may be configured to rotate in connection with one another.

Further, the region where the solar panel 71 is provided is not limited to those exemplified in the above embodiments and modifications, but any region as far as it is a region having a possibility that the external light is blocked by the hour hand 11 and the minute hand 12 that are displaying the time.

Further, in the above, the electronic timepiece 1 is a wristwatch, but may be another type of timepiece, such as a table clock or a wall clock.

Further, in the above, the computer-readable medium storing the program(s) according to the present disclosure is the flash memory of the storage 43, but not limited thereto. The computer-readable medium may be an information storage medium, such as a hard disk drive (HDD), a solid state drive (SSD) or a CD-ROM. Further, carrier waves are also applied to the present disclosure as a medium that provides data of the program(s) according to the present disclosure via a communication line.

Further, it goes without saying that the detailed configuration and operation of each component of the electronic timepiece 1 in the above embodiments and the like can be modified as appropriate without departing from the scope of the present disclosure.

Although one or more embodiments and the like of the present disclosure have been described above, the scope of the present disclosure is not limited to the above-described embodiments and the like, but includes the scope of claims below and the scope of their equivalents.

1. A timepiece comprising:
a first display including a hand;
a second display;
a solar panel provided at a position having a possibility that external light is blocked by the hand that is displaying time; and
at least one processor that controls an operation mode of the first display and the second display,
wherein the at least one processor switches the operation mode between a first mode in which the hand of the first display displays the time and a second mode in which the hand is evacuated to a predetermined evacuation position that makes the external light that is blocked by the hand less as compared to in the first mode and the second display displays the time.

2. The timepiece according to claim 1,
wherein the hand includes an hour hand and a minute hand, and
wherein in the second mode, the at least one processor evacuates the hour hand and the minute hand to the evacuation position so that the hour hand and the minute hand are laid on top of one another.

3. The timepiece according to claim 2, wherein the at least one processor causes the hour hand and the minute hand that are laid on top of one another to make a round, obtains temporal change in electromotive force generated by the solar panel, and determines a position of the hour hand and the minute hand, the position at which a magnitude of the electromotive force satisfies a predetermined condition, as the evacuation position.

4. The timepiece according to claim 1, wherein in the second mode, the at least one processor causes the hand to point to a predetermined mark indicating that the timepiece is operating in the second mode.

5. The timepiece according to claim 1, further comprising a third display,
wherein the solar panel is provided in a region where the third display is not provided as viewed in a direction perpendicular to the solar panel, and
wherein in the second mode, the at least one processor evacuates the hand to the evacuation position at which a part of the hand is laid on the third display.

6. The timepiece according to claim 5, wherein in the second mode, the at least one processor causes the third display to display a predetermined mark indicating that the timepiece is operating in the second mode, and causes the hand to point to the mark.

7. The timepiece according to claim 1,
wherein the solar panel is provided at least in a part of a region where the second display is not provided as viewed in a direction perpendicular to the solar panel, and
wherein the evacuation position is a position at which the hand is not laid on the second display and an area of a part of the solar panel is smallest, the part where the external light is blocked by the hand.

8. The timepiece according to claim 1, wherein in the second mode, the at least one processor evacuates the hand to the evacuation position at which a part of the hand is laid on a part of the second display, and causes the second display to display the time in a region of the second display, the region on which the hand is not laid.

9. The timepiece according to claim 2,
wherein the second display includes a sub hour hand having an area smaller than an area of the hour hand of the first display and a sub minute hand having an area smaller than an area of the minute hand of the first display,
wherein the solar panel is provided at least in a region where the second display is provided as viewed in a direction perpendicular to the solar panel, and
wherein in the second mode, the at least one processor evacuates the hour hand and the minute hand of the first display to the evacuation position at which the hour hand and the minute hand of the first display are not laid on the second display.

10. The timepiece according to claim 2,
wherein the hand further includes a second hand, and
wherein in the second mode, the at least one processor causes the second display to display an hour and a minute, and causes the second hand of the first display to display a second.

11. The timepiece according to claim 2, wherein the at least one processor is capable of rotating the hour hand and the minute hand independently of one another, and in the second mode, evacuates the hour hand and the minute hand to the evacuation position that is a position at which the hour hand and the minute hand are not laid on top of one another while the hour hand and the minute hand are displaying the time.

12. The timepiece according to claim 1, further comprising a dial provided between the hand and the solar panel and including a light transmitting part that transmits the external light and a light blocking part that blocks the external light,
wherein the solar panel is provided in a region where the light blocking part is not provided as viewed in a direction perpendicular to the solar panel, and
wherein in the second mode, the at least one processor evacuates the hand to the evacuation position at which a part of the hand is laid on the light blocking part.

13. A display control method that is performed by a computer of a timepiece including a first display including a hand, a second display, and a solar panel provided at a position having a possibility that external light is blocked by the hand that is displaying time, the display control method comprising:
switching an operation mode of the first display and the second display between a first mode in which the hand of the first display displays the time and a second mode in which the hand is evacuated to a predetermined evacuation position that makes the external light that is blocked by the hand less as compared to in the first mode and the second display displays the time.

14. The display control method according to claim 13
wherein the hand includes an hour hand and a minute hand, and
wherein in the second mode, the hour hand and the minute hand are evacuated to the evacuation position so that the hour hand and the minute hand are laid on top of one another.

15. The display control method according to claim 14, further comprising:
causing the hour hand and the minute hand that are laid on top of one another to make a round;
obtaining temporal change in electromotive force generated by the solar panel; and
determining a position of the hour hand and the minute hand, the position at which a magnitude of the electromotive force satisfies a predetermined condition, as the evacuation position.

16. The display control method according to claim 13, wherein in the second mode, the hand is evacuated to the evacuation position at which a part of the hand is laid on a part of the second display, and the second display is caused to display the time in a region of the second display, the region on which the hand is not laid.

17. A non-transitory computer-readable storage medium storing a program causing, of a timepiece including a first display including a hand, a second display, and a solar panel provided at a position having a possibility that external light is blocked by the hand that is displaying time, a computer to:
switch an operation mode of the first display and the second display between a first mode in which the hand of the first display displays the time and a second mode in which the hand is evacuated to a predetermined evacuation position that makes the external light that is blocked by the hand less as compared to in the first mode and the second display displays the time.

18. The non-transitory computer-readable storage medium according to claim 17,
wherein the hand includes an hour hand and a minute hand, and
wherein the program causes the computer to, in the second mode, evacuate the hour hand and the minute hand to the evacuation position so that the hour hand and the minute hand are laid on top of one another.

19. The non-transitory computer-readable storage medium according to claim 18, wherein the program further causes the computer to:
cause the hour hand and the minute hand that are laid on top of one another to make a round;
obtain temporal change in electromotive force generated by the solar panel; and
determine a position of the hour hand and the minute hand, the position at which a magnitude of the electromotive force satisfies a predetermined condition, as the evacuation position.

20. The non-transitory computer-readable storage medium according to claim 17, wherein the program causes the computer to, in the second mode, evacuate the hand to the evacuation position at which a part of the hand is laid on a part of the second display, and cause the second display to display the time in a region of the second display, the region on which the hand is not laid.
